(19) United States
(12) Patent Application Publication
(10) Pub. No.: US 2026/0189912 A1
(43) Pub. Date: Jul. 2, 2026

(54) KEY DISTRIBUTION METHODS, AND APPARATUSES, DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 19/127,612

(22) PCT Filed: Nov. 7, 2022
(86) PCT No.: PCT/CN2022/130426

§ 371 Date: May 6, 2025

(51) Int. Cl. H04W 12/069; H04W 12/033; H04W 12/0431; H04W 12/0433

(52) U.S. Cl. CPC H04W 12/069; H04W 12/033; H04W 12/0431; H04W 12/0433

(57) ABSTRACT

Key distribution methods, communication apparatuses, and storage mediums are provided. A key distribution method includes: receiving a first request message, where the first request message is for requesting an AKMA application key; determining whether an AF entity is within a 3GPP operator domain, where the AF entity is an entity for which the AKMA application key is requested to communicate with a terminal device; and distributing the AKMA application key based on a result of the determining.

### CROSS-REFERENCE TO RELATED APPLICATIONS

The present disclosure is a U.S. national phase of PCT Application No. PCT/CN2022/130426 filed on Nov. 7, 2022, the content of which is hereby incorporated by reference in its entirety.

### TECHNICAL FIELD

The present disclosure relates to a field of communication technologies, and in particular, to key distribution methods, communication apparatuses, and storage mediums.

### BACKGROUND

In a communication system, a security of communication between a terminal device and an application function (AF) entity is usually protected based on authentication and key management for applications (AKMA) of a 3rd generation partnership project (3GPP) credential.

### SUMMARY

In a first aspect, an embodiment of the present disclosure provides a key distribution method. The method is performed by a first authentication and key management for applications anchor function (AAnF) network element, and includes: receiving a first request message, where the first request message is for requesting an authentication and key management for applications (AKMA) application key; determining whether an application function (AF) entity is within a 3rd generation partnership project (3GPP) operator domain, where the AF entity is an entity that needs to communicate with a terminal device through the AKMA application key; and distributing the AKMA application key based on a result of the determining.

In a second aspect, an embodiment of the present disclosure provides a key distribution method. The method is performed by an NF network element in a first network, and includes: sending first indication information to an authentication and key management for applications anchor function (AAnF) network element in the first network, where the first indication information indicates whether an AF entity is within a 3GPP operator domain, and the AF entity is an entity that needs to communicate with a terminal device through an AKMA application key.

In a third fourth aspect, an embodiment of the present disclosure provides a key distribution method. The method is performed by an NF network element in a second network, and includes: receiving a first response message sent by an AAnF network element in a first network; where the first response message includes at least one of: the AKMA application key; a valid time of the AKMA application key; or an invalid time of the AKMA application key; an SUPI of a terminal device, where the terminal device is a terminal device with which the AF entity needs to communicate through the AKMA application key; or an identifier of the AF entity (AF_ID).

In a fourth aspect, an embodiment of the present disclosure provides a communication apparatus. The communication apparatus includes a processor and a memory, the memory stores a computer program, and the processor executes the computer program stored in the memory, to cause the communication apparatus to perform the method in any one of the first to third aspects.

In a fifth aspect, an embodiment of the present disclosure provides a computer-readable storage medium, configured to store instructions used for the above network device. When the instructions are executed, the terminal device performs the method in any one of the first to third aspects.

### BRIEF DESCRIPTION OF DRAWINGS

The above and/or additional aspects and advantages of the present disclosure will become apparent and readily understood from the following description of embodiments in conjunction with the accompanying drawings.

FIG. 1 is a schematic architectural diagram of a communication system provided by an embodiment of the present disclosure.

FIG. 2 is a schematic flowchart of a key distribution method provided by another embodiment of the present disclosure.

FIG. 3 is a schematic flowchart of a key distribution method provided by still another embodiment of the present disclosure.

FIG. 4 is a schematic flowchart of a key distribution method provided by yet another embodiment of the present disclosure.

FIGS. 5a-5b are schematic flowcharts of a key distribution method provided by another embodiment of the present disclosure.

FIG. 6 is a schematic flowchart of a key distribution method provided by still another embodiment of the present disclosure.

FIGS. 7a-7c are schematic flowcharts of a key distribution method provided by yet another embodiment of the present disclosure.

FIG. 8 is a schematic flowchart of a key distribution method provided by yet another embodiment of the present disclosure.

FIG. 9 is a schematic flowchart of a key distribution method provided by yet another embodiment of the present disclosure.

FIG. 10 is a schematic flowchart of a key distribution method provided by yet another embodiment of the present disclosure.

FIG. 11 is a schematic flowchart of a key distribution method provided by yet another embodiment of the present disclosure.

FIG. 12 is a schematic flowchart of a key distribution method provided by yet another embodiment of the present disclosure.

FIG. 13 is a schematic flowchart of a key distribution method provided by yet another embodiment of the present disclosure.

FIGS. 14a-14r are schematic flowcharts of a key distribution method provided by yet another embodiment of the present disclosure.

FIG. 15 is a schematic interaction diagram of a key distribution method provided by yet another embodiment of the present disclosure.

FIG. 16 is a schematic structural diagram of a communication apparatus provided by an embodiment of the present disclosure.

FIG. 17 is a schematic structural diagram of a communication apparatus provided by another embodiment of the present disclosure.

FIG. 18 is a schematic structural diagram of a communication apparatus provided by another embodiment of the present disclosure.

FIG. 19 is a schematic structural diagram of a communication apparatus provided by another embodiment of the present disclosure.

FIG. 20 is a schematic structural diagram of a communication apparatus provided by an embodiment of the present disclosure.

FIG. 21 is a schematic structural diagram of a chip provided by an embodiment of the present disclosure.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. Rather, they are only examples of apparatuses and methods that are consistent with some aspects of embodiments of the present disclosure as detailed in the attached claims.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, terms “if” and “in case of” used herein may be interpreted as “when,” “while,” or “in response to determining.”

Embodiments of the present disclosure are described in detail below. Examples of the embodiments are shown in the accompanying drawings, where identical or similar reference signs throughout represent identical or similar elements. The embodiments described below with reference to the accompanying drawings are exemplary and intended to explain the present disclosure, but cannot be understood as limiting the present disclosure.

For ease of understanding, terms involved in the present disclosure are first described.

### 1. 5th Generation Mobile Networks (5G) Technology

The 5G technology is a new generation broadband mobile communication technology with characteristics of a high rate and a low delay, and is a network infrastructure for interconnecting humans, machines, and things.

### 2. Home Network

The home network is a network provided by an operator to which a terminal device is subscribed.

### 3. Visited Network

The visited network is a network provided by another operator other than the operator to which the terminal device is subscribed.

In the communication system, an AKMA application key is usually used to protect the security of the communication between a terminal device and an AF entity. The AKMA application key used by the terminal device side is generated by the terminal device, and the AKMA application key used by the AF entity side is generated by a home network for the terminal device based on information provided by the terminal device. In addition, in the communication system, the terminal device may be in a roaming state, that is, a current visited network for the terminal device is different from the home network for the terminal device. At this time, the current visited network usually needs to control the AF entity to send the AKMA application key to itself, such that the current visited network parses a relevant service between the terminal device and the AF entity. However, the AF entity communicating with the terminal device may be an AF entity managed by an operator (for example, China Mobile, China Unicom, or China Telecom), or may be a third-party AF entity (external AF entity) that is not managed by the operator (for example, the third-party AF entity may be an AF entity managed by Tencent). When the AF entity communicating with the terminal device is the third-party AF that is not managed by the operator, the third-party AF entity is not controlled by the operator. In this case, if the terminal device is still in the roaming state, the third-party AF entity is not controlled by the current visited network, so that the current visited network for the terminal device cannot control the third-party AF to send the AKMA application key to itself, that is, if the current visited network for the terminal device cannot learn of the AKMA application key, the parsing of the service between the terminal device and the AF entity by the current visited network is affected, thereby affecting performing of the service.

Based on this, the present disclosure provides a key distribution method.

In order to better understand the key distribution method disclosed in the embodiments of the present disclosure, a communication system applicable to the embodiments of the present disclosure is described firstly below.

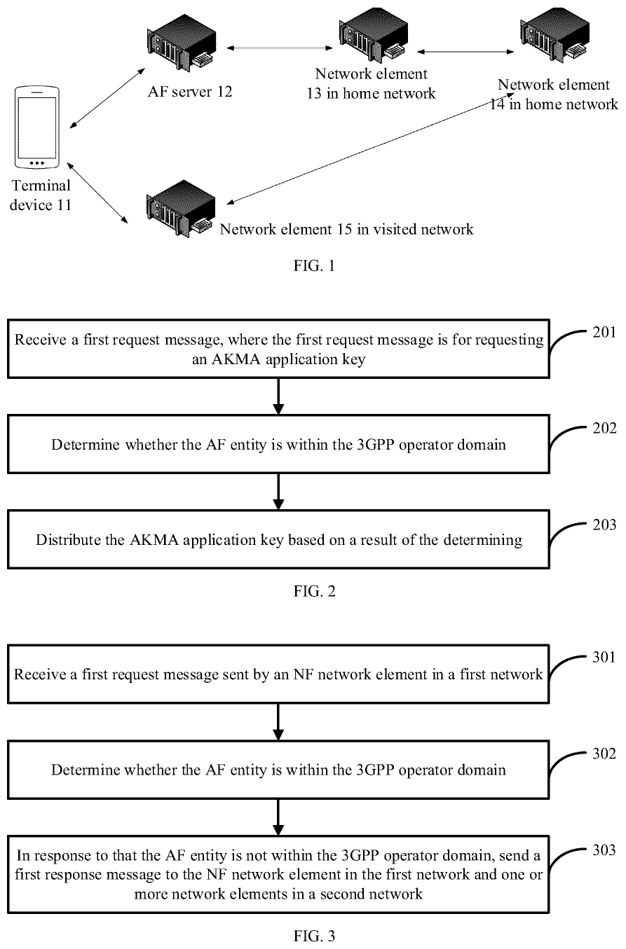

Referring to FIG. 1, FIG. 1 is a schematic architectural diagram of a communication system provided by an embodiment of the present disclosure. The communication system may include but is not limited to a terminal device, a server (for example, an AF server), a network element in the home network, and a network element in the visited network. The number of devices and forms of the devices shown in FIG. 1 are only exemplary and do not constitute limitations to the embodiments of the present disclosure. In a practical application, the communication system may include one or more terminals, one or more servers, one or more network elements in the home network, or one or more network elements in the visited network. The communication system shown in FIG. 1 may include one terminal device 11, one AF server 12, two network elements 13 and 14 in the home network, and one network element 15 in the visited network, for example.

It should be noted that technical solutions of the embodiments of the present disclosure may be applied to various types of communication systems, for example, a long term evolution (LTE) system, a 5th generation (5G) mobile communication system, a 5G new radio (NR) system, or other future new mobile communication systems, etc.

The terminal device 11 in the embodiments of the present disclosure may be an entity for receiving or sending a signal on a user-side, for example a mobile phone. The terminal device may also be referred to as a terminal, user equipment (UE), a mobile station (MS), a mobile terminal (MT), etc. The UE may be a car with a communication function, a smart car, a mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. Specific technologies and specific device forms used by the UE are not limited in the embodiments of the present disclosure.

The network element 13 in the home network in the embodiments of the present disclosure may be a network function (NF) network element. The network element 14 in the home network in the embodiments of the present disclosure may be an authentication and key management for applications anchor function (AAnF) network element. The network element 15 in the visited network in the embodiments of the present disclosure may be at least one of: an AAnF network element, a user plane function (UPF) network element, an access and mobility management function (AMF) network element, or an NF network element.

It should be noted that the NF network element of the present disclosure may also be referred to as a network exposure function (NEF) network element.

In addition, names of the entities provided in the present disclosure are merely exemplary. However, it should be understood that any entity with another name that may implement the function implemented by the entity of the present disclosure is also within the protection scope of the present disclosure, for example, a network element A. If the network element A may also implement the function implemented by an AAnF network element in a first network in the present disclosure, performing the method of the present disclosure by the network element A should also be within the protection scope of the present disclosure.

It may be understood that the communication system described in the embodiments of the present disclosure is used to describe the technical solutions in the embodiments of the present disclosure more clearly, and does not constitute a limitation on the technical solutions provided in the embodiments of the present disclosure. Those skilled in the art may know that with evolution of system architectures and emergence of new business scenarios, the technical solutions provided in the embodiments of the present disclosure are also applicable to similar technical problems.

The key distribution methods, the apparatuses, the device, and the storage medium provided by the embodiments of the present disclosure will be described in detail below with reference to the accompanying drawings.

It should be noted that, in the present disclosure, the key distribution method provided by any one embodiment or any one implementation manner in the embodiments may be performed separately, or may be performed together with other embodiments, possible implementation manners in other embodiments, or any one technical solution in related technologies.

In addition, in the present disclosure, a mentioned first network may be a home network for the terminal device, and a mentioned second network may be a current visited network for the terminal device. The current visited network may be the same as or different from the home network. When the current visited network is different from the home network, it indicates that the terminal device is currently in the roaming state.

FIG. 2 is a schematic flowchart of a key distribution method provided by an embodiment of the present disclosure. The method is performed by an AAnF network element in a first network. As shown in FIG. 2, the key distribution method may include the following steps 201-203.

At step 201, a first request message is received, where the first request message is for requesting an AKMA application key.

It should be noted that an application scenario for the method according to the present disclosure is mainly as follows: the AF entity communicating with the terminal device is not within the 3GPP operator domain, and the terminal device is still in a roaming state.

In addition, in an embodiment of the present disclosure, the first request message may be sent by the AF entity to the AAnF network element in the first network through the NF network element in the first network. Alternatively, in an embodiment of the present disclosure, the first request message may be sent by one or more network elements in the second network to the AAnF network element in the first network. The AF entity may be an entity that needs to communicate with the terminal device through the AKMA application key.

In an embodiment of the present disclosure, the one or more network elements in the second network may include at least one of:
an AAnF network element in the second network;
a UPF network element in the second network;
an AMF network element in the second network; or
the NF network element in the second network.

In addition, in an embodiment of the present disclosure, the first request message may include at least one of:
a key identifier (A-KID);
an identifier of the AF entity (AF_ID); or
an identifier of the terminal device.

The identifier of the terminal device may include at least one of: a general public subscription identifier (GPSI), a subscription concealed identifier (SUCI), or a subscription permanent identifier (SUPI).

It should be noted that the A-KID may be generated by the terminal device and sent to the AF entity, and provided by the AF entity to the AAnF network element in the first network. For example, after the terminal device generates an A-KID, the terminal device may provide the A-KID to the AF entity with a session establishment request.

At step 202, it is determined whether the AF entity is within the 3GPP operator domain.

In an embodiment of the present disclosure, the method of determining whether the AF entity is within the 3GPP operator domain may include at least one of:
determining, based on the AF_ID and/or a local policy of the AAnF network element, whether the AF entity is within the 3GPP operator domain; or
receiving first indication information sent by the AF entity or an NF network element in the first network, where the first indication information indicates whether the AF entity is within the 3GPP operator domain, and determining, based on the first indication information, whether the AF entity is within the 3GPP operator domain.

In an embodiment of the present disclosure, the first indication information may be generated by the NF network element in the first network. For example, the NF network element in the first network may determine, based on the AF_ID and/or a local policy of the NF network element, whether the AF entity is within the 3GPP operator domain, to generate the first indication information.

In another embodiment of the present disclosure, the first indication information may alternatively be generated by the AF entity, and is sent to the AAnF network element in the first network through the NF network element in the first network. For example, the AF entity may determine whether the AF entity is within the 3GPP operator domain based on the AF_ID, to generate the first indication information.

It should be noted that, in an embodiment of the present disclosure, the first indication information may be included in the first request message and sent to the AAnF network element in the first network; or, in another embodiment of the present disclosure, the first indication information may also be separately sent to the AAnF network element in the first network with respect to the first request message.

At step 203, the AKMA application key is distributed based on a result of the determining.

In an embodiment of the present disclosure, the AKMA application key may be generated by an AAnF network element in the first network based on the A-KID. Specifically, the AAnF network element in the first network may determine, based on the A-KID, an AKMA anchor key (K_{AKMA}) corresponding to the terminal device corresponding to the A-KID. For example, the AAnF network element in the first network may obtain a corresponding K_{AKMA} from an authentication server function (AUSF) network element based on the A-KID; and then, the AAnF network element in the first network may generate an AKMA application key based on the A-KID and the K_{AKMA}, where the AKMA application key is used for encryption to protect the security of the communication between the terminal device and the AF entity.

In addition, it should be noted that, according to content written in the foregoing embodiment, when the AF entity is not within the 3GPP operator domain, it indicates that the AF entity is not controlled by the operator. In this case, if the terminal device is still in the roaming state, the current visited network for the terminal device cannot obtain the AKMA application key used for the communication between the terminal device and the AF entity, thereby affecting parsing of the service between the terminal device and the AF entity by the current visited network, and then affecting the service. Based on this, in an embodiment of the present disclosure, after the AAnF network element in the first network generates the AKMA application key, the AAnF network element may distribute the AKMA application key, based on a result of the determining (or determination result) whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

How the AAnF network element in the first network specifically distributes the AKMA application key based on the result of determining will be described in subsequent embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 3 is a schematic flowchart of a key distribution method provided by an embodiment of the present disclosure. The method is performed by an AAnF network element in a first network. As shown in FIG. 3, the key distribution method may include the following steps 301-303.

At step 301, a first request message sent by an NF network element in a first network is received, where the first request message is for requesting an AKMA application key.

At step 302, it is determined whether the AF entity is within the 3GPP operator domain.

The detailed description of the steps 301-302 may refer to the description of the above embodiments.

At step 303, in response to that the AF entity is not within the 3GPP operator domain, a first response message is sent to the NF network element in the first network and one or more network elements in a second network.

In an embodiment of the present disclosure, the first response message may include at least one of:
the AKMA application key;
a valid time of the AKMA application key, where the valid time may be a valid time period of the AKMA application key;
an invalid time of the AKMA application key, where the invalid time may be an invalid time period of the AKMA application key;
a SUPI of the terminal device; or
an AF_ID of the AF entity.

In addition, in an embodiment of the present disclosure, “the AF entity being not within the 3GPP operator domain” may be understood as that: the AF entity is not in any one 3GPP operator domain, that is, the AF entity is a third-party AF entity (external AF entity) managed by a third-party (for example, the third-party AF entity may be an AF entity managed by Tencent). In this case, the AF entity is not controlled by the first network and the second network. In the present disclosure, the AF entity outside the 3GPP operator domain may refer to an external AF entity in the data network (internet).

Based on this, in an embodiment of the present disclosure, the AAnF network element in the first network sends the first response message to the NF network element in the first network, such that the NF network element in the first network can forward information in the first response message to the AF entity, and the AF entity can protect the security of the communication between the NF network element and the corresponding AF entity based on the AKMA application key within the valid time of the AKMA application key.

Further, in an embodiment of the present disclosure, the AAnF network element in the first network sends the first response message to the network element in the second network, such that when the AKMA application key cannot be provided to the network element in the second network due to the AF entity being not within the 3GPP operator domain, the network element in the second network may learn of the AKMA application key and related information based on the first response message, and the network element in the second network can smoothly parse a service between the AF entity and a corresponding terminal device based on the AKMA application key within the valid time of the AKMA application key, to ensure that the service is successfully performed.

In an embodiment of the present disclosure, the one or more network elements in the second network may include at least one of:
an AAnF network element in the second network;
a UPF network element in the second network;
an AMF network element in the second network; or
the NF network element in the second network.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity for which the AKMA application key is required to communicate with the terminal device; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

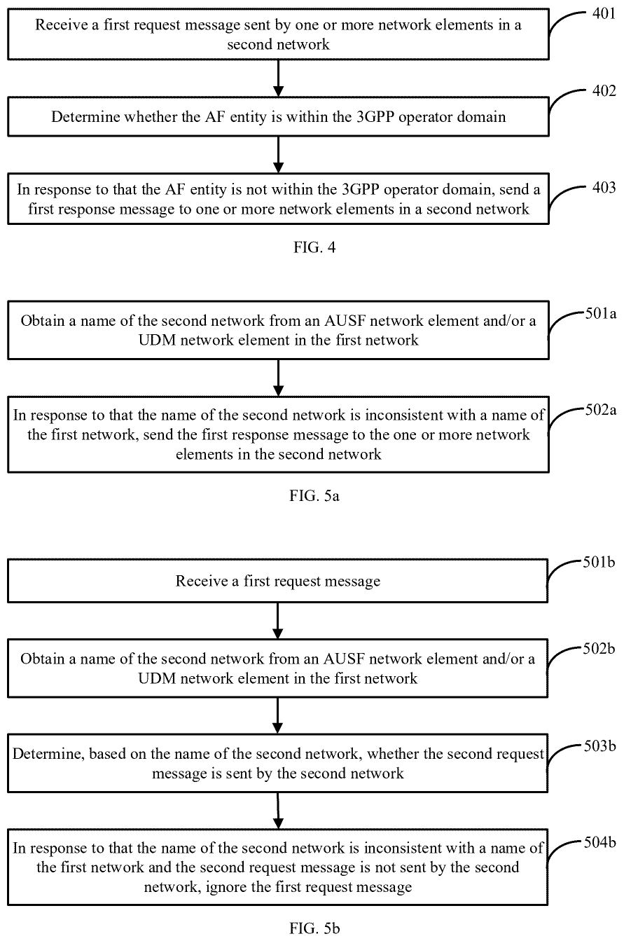

FIG. 4 is a schematic flowchart of a key distribution method provided by an embodiment of the present disclosure. The method is performed by an AAnF network element in a first network. As shown in FIG. 4, the key distribution method may include the following steps 401-403.

At step 401, a first request message sent by one or more network elements in a second network is received, where the first request message is for requesting an AKMA application key.

In an embodiment of the present disclosure, the one or more network elements in the second network may include at least one of:
an AAnF network element in the second network;
a UPF network element in the second network;
an AMF network element in the second network; or
the NF network element in the second network.

At step 402, it is determined whether the AF entity is within the 3GPP operator domain.

At step 403, in response to that the AF entity is not within the 3GPP operator domain, a first response message is sent to one or more network elements in a second network.

The detailed description of the steps 401-403 may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 5a is a schematic flowchart of a key distribution method provided by an embodiment of the present disclosure. The method is performed by an AAnF network element in a first network. As shown in FIG. 5a, the key distribution method may include the following steps 501a-502a.

At step 501a, a name of the second network is obtained from an AUSF network element and/or a unified data management (UDM) network element in the first network.

In an embodiment of the present disclosure, the AUSF network element may simultaneously provide the name of the second network for the terminal device to the AAnF network element in the first network when providing the AKMA anchor key (K_{AKMA}) to the AAnF network element in the first network.

At step 502a, in response to that the name of the second network is inconsistent with a name of the first network, the first response message is sent to the one or more network elements in the second network.

In an embodiment of the present disclosure, when the name of the second network is inconsistent with the name of the first network, it indicates that the current visited network for the terminal device is not the home network for the terminal device, that is, the terminal device is currently roaming, and in this case, the first network needs to send the first response message to the network element in the second network to provide the AKMA application key and the related information, thereby ensuring that when “the AF entity is not within the 3GPP operator domain and the terminal device is in the roaming state”, the second network (that is, the visited network) can know the AKMA application key based on sending of the AAnF network element in the first network, thereby ensuring that the service is successfully performed.

In an embodiment of the present disclosure, the one or more network elements in the second network may include at least one of:
an AAnF network element in the second network;
a UPF network element in the second network;
an AMF network element in the second network; or
the NF network element in the second network.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 5 is a schematic flowchart of a key distribution method provided by an embodiment of the present disclosure. The method is performed by an AAnF network element in a first network. As shown in FIG. 5b, the key distribution method may include the following steps 501b-504b.

At step 501b, a first request message is received, where the first request message is for requesting an AKMA application key.

It should be noted that a premise of the embodiment of FIG. 5b in the present disclosure is that the first request message is not sent by the AF entity or the NF network element in the first network to the AAnF network element in the first network.

At step 502b, a name of the second network is obtained from an AUSF network element and/or a UDM network element in the first network.

At step 503b, it is determined, based on the name of the second network, whether the second request message is sent by the second network.

At step 504b, in response to that the name of the second network is inconsistent with a name of the first network and the second request message is not sent by the second network, the first request message is ignored.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

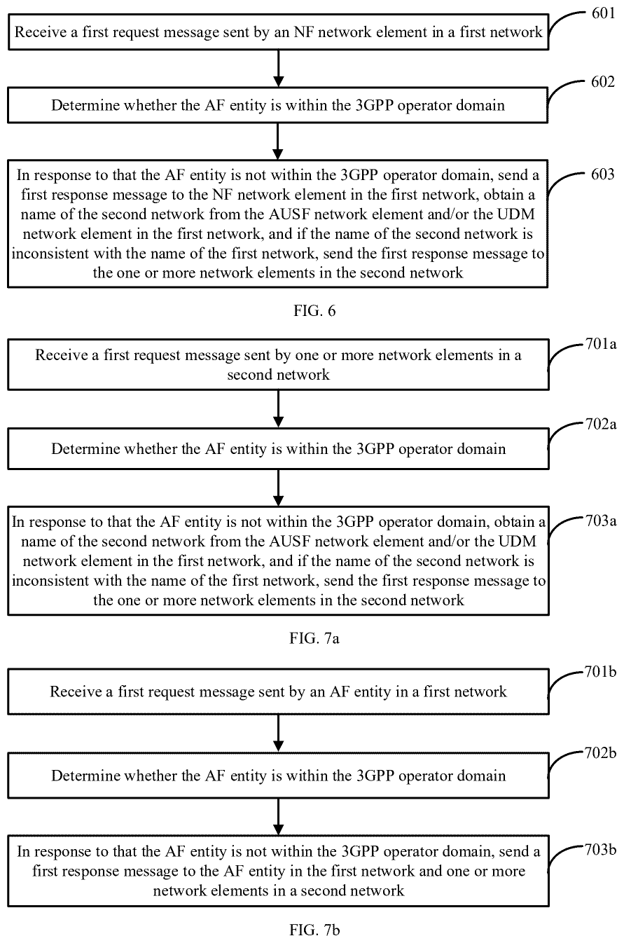

FIG. 6 is a schematic flowchart of a key distribution method provided by an embodiment of the present disclosure. The method is performed by an AAnF network element in a first network. As shown in FIG. 6, the key distribution method may include the following steps 601-603.

At step 601, a first request message sent by an NF network element in a first network is received, where the first request message is for requesting an AKMA application key.

At step 602, it is determined whether the AF entity is within the 3GPP operator domain.

At step 603, in response to that the AF entity is not within the 3GPP operator domain, a first response message is sent to the NF network element in the first network, a name of the second network is obtained from the AUSF network element and/or the UDM network element in the first network, and if the name of the second network is inconsistent with the name of the first network, the first response message is sent to the one or more network elements in the second network.

In an embodiment of the present disclosure, the one or more network elements in the second network may include at least one of:
an AAnF network element in the second network;
a UPF network element in the second network;
an AMF network element in the second network; or
the NF network element in the second network.

The detailed description of the steps 601-603 may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

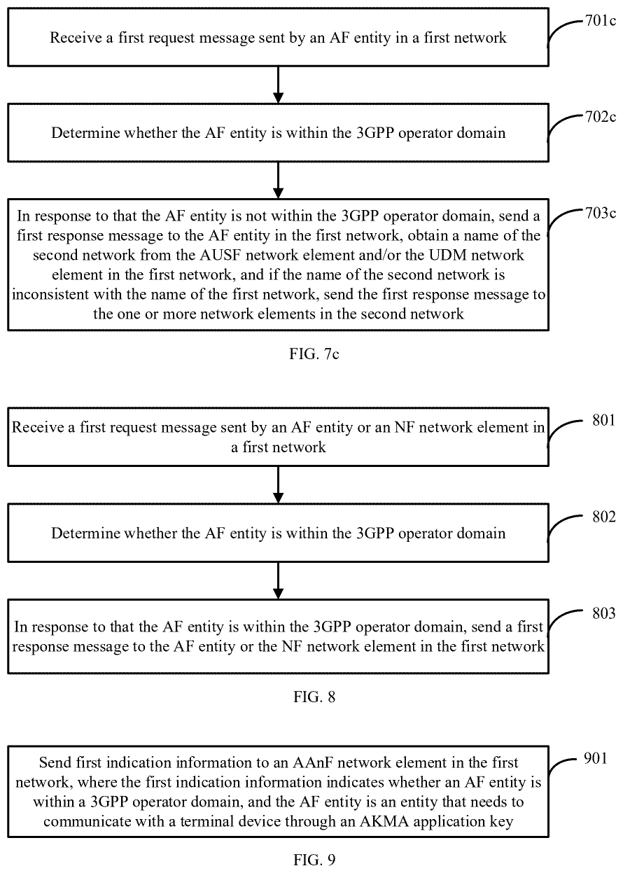

FIG. 7a is a schematic flowchart of a key distribution method provided by an embodiment of the present disclosure. The method is performed by an AAnF network element in a first network. As shown in FIG. 7a, the key distribution method may include the following steps 701a-703a.

At step 701a, a first request message sent by one or more network elements in a second network is received, where the first request message is for requesting an AKMA application key.

In an embodiment of the present disclosure, the one or more network elements in the second network may include at least one of:
an AAnF network element in the second network;
a UPF network element in the second network;
an AMF network element in the second network; or
the NF network element in the second network.

At step 702a, it is determined whether the AF entity is within the 3GPP operator domain.

At step 703a, in response to that the AF entity is not within the 3GPP operator domain, a name of the second network is obtained from the AUSF network element and/or the UDM network element in the first network, and if the name of the second network is inconsistent with the name of the first network, the first response message is sent to the one or more network elements in the second network.

The detailed description of the steps 701a-703a may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 7b is a schematic flowchart of a key distribution method provided by an embodiment of the present disclosure. The method is performed by an AAnF network element in a first network. As shown in FIG. 7b, the key distribution method may include the following steps 701b-703b.

At step 701b, a first request message sent by an AF entity in a first network is received, where the first request message is for requesting an AKMA application key.

At step 702b, it is determined whether the AF entity is within the 3GPP operator domain.

At step 703b, in response to that the AF entity is not within the 3GPP operator domain, a first response message is sent to the AF entity in the first network and one or more network elements in a second network.

In an embodiment of the present disclosure, the one or more network elements in the second network may include at least one of:
an AAnF network element in the second network;
a UPF network element in the second network;
an AMF network element in the second network; or the NF network element in the second network.

The detailed description of the steps 701b-703b may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 7c is a schematic flowchart of a key distribution method provided by an embodiment of the present disclosure. The method is performed by an AAnF network element in a first network. As shown in FIG. 7, the key distribution method may include the following steps 701c-703c.

At step 701c, a first request message sent by an AF entity in a first network is received, where the first request message is for requesting an AKMA application key.

At step 702c, it is determined whether the AF entity is within the 3GPP operator domain.

At step 703c, in response to that the AF entity is not within the 3GPP operator domain, a first response message is sent to the AF entity in the first network, a name of the second network is obtained from the AUSF network element and/or the UDM network element in the first network, and if the name of the second network is inconsistent with the name of the first network, the first response message is sent to the one or more network elements in the second network.

In an embodiment of the present disclosure, the one or more network elements in the second network may include at least one of:
an AAnF network element in the second network;
a UPF network element in the second network;
an AMF network element in the second network; or
the NF network element in the second network.

The detailed description of the steps 701b-703b may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 8 is a schematic flowchart of a key distribution method provided by an embodiment of the present disclosure. The method is performed by an AAnF network element in a first network. As shown in FIG. 8, the key distribution method may include the following steps 801-803.

At step 801, a first request message sent by an AF entity or an NF network element in a first network is received, where the first request message is for requesting an AKMA application key.

At step 802, it is determined whether the AF entity is within the 3GPP operator domain.

At step 803, in response to that the AF entity is within the 3GPP operator domain, a first response message is sent to the AF entity or the NF network element in the first network.

In an embodiment of the present disclosure, both the first network and the second network may control the AF entity when the AF entity is within the 3GPP operator domain. In addition, “the AF entity is within the 3GPP operator domain” may be understood as: the AF entity is within the 3GPP operator domain of the first network, or the AF entity is within the 3GPP operator domain of the second network. In the present disclosure, AF entities within the 3GPP operator domain may refer to an internal HPLMN AF entity and an internal VPLMN AF entity. The HPLMN is a home public land mobile network, and the VPLMN is a visited public land mobile network.

It should be noted that, in an embodiment of the present disclosure, when the AF entity is within the 3GPP operator domain of the first network, the AAnF network element in the first network may directly communicate with the AF entity; and when the AF entity is within the 3GPP operator domain of the second network and the first network is different from the second network, the AAnF network element in the first network communicates with the AF entity through the NF network element in the first network.

Based on this, in an embodiment of the present disclosure, if the first network is the same as the second network, that is, when the terminal device is not roaming, and when the AF entity is within the 3GPP operator domain of the first network, the AAnF network element in the first network may directly send the first response message to the AF entity.

If the first network is different from the second network, that is, the AAnF network element in the first network knows that the terminal device is roaming, in this case, when the AF entity is within the 3GPP operator domain of the first network, the AAnF network element in the first network may directly send the first response message to the AF entity and the network element in the second network may control the AF entity to forward information in the first response message to itself, or the AAnF network element in the first network may also send the first response message to the network element in the second network, to ensure that the second network can know information (that is, the AKMA application key) in the first response message, thereby ensuring that the service is successfully performed.

If the first network is different from the second network, that is, the AAnF network element in the first network knows that the terminal device is roaming, and when the AF entity is within the 3GPP operator domain of the second network, the AAnF network element in the first network may send the first response message to the AF entity through the NF network element in the first network, and the network element in the second network may control the AF entity to forward information in the first response message to itself, or the AAnF network element in the first network may also send the first response message to the network element in the second network, to ensure that the second network can know information (that is, the AKMA application key) in the first response message, thereby ensuring that the service is successfully performed.

In an embodiment of the present disclosure, the one or more network elements in the second network may include at least one of:
an AAnF network element in the second network;
a UPF network element in the second network;
an AMF network element in the second network; or
the NF network element in the second network.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 9 is a schematic flowchart of a key distribution method provided by an embodiment of the present disclosure. The method is performed by an NF network element in a first network. As shown in FIG. 9, the key distribution method may include the following step 901.

At step 901, first indication information is sent to an AAnF network element in the first network, where the first indication information indicates whether an AF entity is within a 3GPP operator domain, and the AF entity is an entity that needs to communicate with a terminal device through an AKMA application key.

The detailed description of the step 901 may refer to the description of the above embodiments.

To sum up, in the key distribution method provided in the present disclosure, the NF network element in the first network may send first indication information to the AAnF network element in the first network, where the first indication information indicates whether the AF entity is within the 3GPP operator domain, and the AF entity is an entity that needs to communicate with the terminal device through the AKMA application key, so that the AAnF network element in the first network determines, based on the first indication message, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

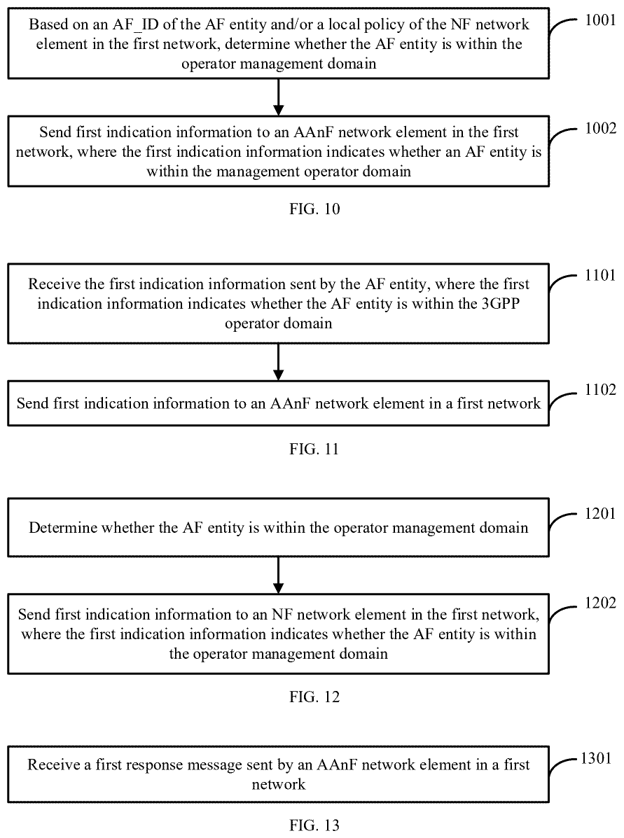

FIG. 10 is a schematic flowchart of a key distribution method provided by an embodiment of the present disclosure. The method is performed by an NF network element in a first network. As shown in FIG. 10, the key distribution method may include the following steps 1001-1002.

At step 1001, based on an AF_ID of the AF entity and/or a local policy of the NF network element in the first network, it is determined whether the AF entity is within the 3GPP operator domain.

At step 1002, first indication information is sent to an AAnF network element in the first network, where the first indication information indicates whether an AF entity is within a 3GPP operator domain, and the AF entity is an entity that needs to communicate with a terminal device through an AKMA application key.

The detailed description of the steps 1001-1002 may refer to the description of the above embodiments.

To sum up, in the key distribution method provided in the present disclosure, the NF network element in the first network may send first indication information to the AAnF network element in the first network, where the first indication information indicates whether the AF entity is within the 3GPP operator domain, and the AF entity is an entity that needs to communicate with the terminal device through the AKMA application key, so that the AAnF network element in the first network determines, based on the first indication message, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 11 is a schematic flowchart of a key distribution method provided by an embodiment of the present disclosure. The method is performed by an NF network element in a first network. As shown in FIG. 11, the key distribution method may include the following steps 1101-1102.

At step 1101, the first indication information sent by the AF entity is received, where the first indication information indicates whether the AF entity is within the 3GPP operator domain.

At step 1102, first indication information is sent to an AAnF network element in a first network.

The detailed description of the steps 1101-1102 may refer to the description of the above embodiments.

To sum up, in the key distribution method provided in the present disclosure, the NF network element in the first network may send first indication information to the AAnF network element in the first network, where the first indication information indicates whether the AF entity is within the 3GPP operator domain, and the AF entity is an entity that needs to communicate with the terminal device through the AKMA application key, so that the AAnF network element in the first network determines, based on the first indication message, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 12 is a schematic flowchart of a key distribution method provided by an embodiment of the present disclosure. The method is performed by an AF entity. As shown in FIG. 12, the key distribution method may include the following steps 1201-1202.

At step 1201, it is determined whether the AF entity is within the 3GPP operator domain.

At step 1202, first indication information is sent to a network function (NF) network element in the first network, where the first indication information indicates whether the AF entity is within the 3GPP operator domain.

In an embodiment of the present disclosure, the AF entity may first find the NF network element in the first network for the terminal device based on the A-KID of the terminal device, and then send the first indication information to the NF network element in the first network. It should be noted that, in an embodiment of the present disclosure, the A-KID may be carried in a session establishment request sent by the terminal device and sent to the AF entity.

The detailed description of the steps 1201-1202 may refer to the description of the above embodiments.

To sum up, in the key distribution method provided in the present disclosure, the AF entity determines whether the AF entity is within the 3GPP operator domain, and sends a first indication information to the NF network element in the first network, where the first indication information indicates whether the AF entity is within the 3GPP operator domain, and the NF network element in the first network may send the first indication information to the AAnF network element in the first network, so that the AAnF network element in the first network determines, based on the first indication information, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 13 is a schematic flowchart of a key distribution method provided by an embodiment of the present disclosure. The method is performed by a network element in a second network. As shown in FIG. 13, the key distribution method may include the following step 1301.

At step 1301, a first response message sent by an AAnF network element in a first network is received.

Optionally, the first response message includes at least one of:
the AKMA application key;
a valid time of the AKMA application key; or
an SUPI of a terminal device, where the terminal device is a terminal device with which the AF entity needs to communicate through the AKMA application key.

In an embodiment of the present disclosure, the one or more network elements in the second network may include at least one of:
an AAnF network element in the second network;
a UPF network element in the second network;
an AMF network element in the second network; or
the NF network element in the second network.

The detailed description of the step 1301 may refer to the description of the above embodiments.

To sum up, in the key distribution method provided in the present disclosure, the network element in the second network receives the first response message sent by the AAnF network element in the first network. In the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

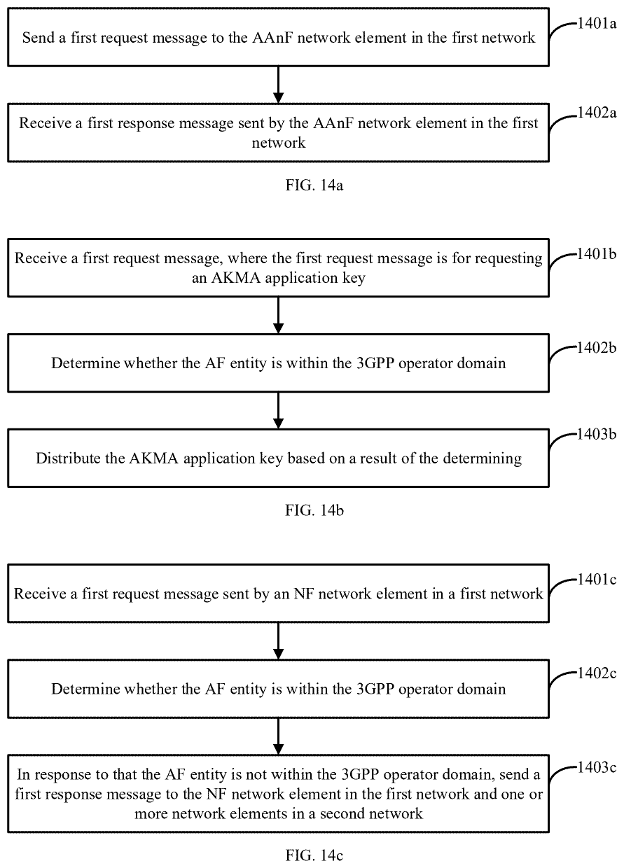

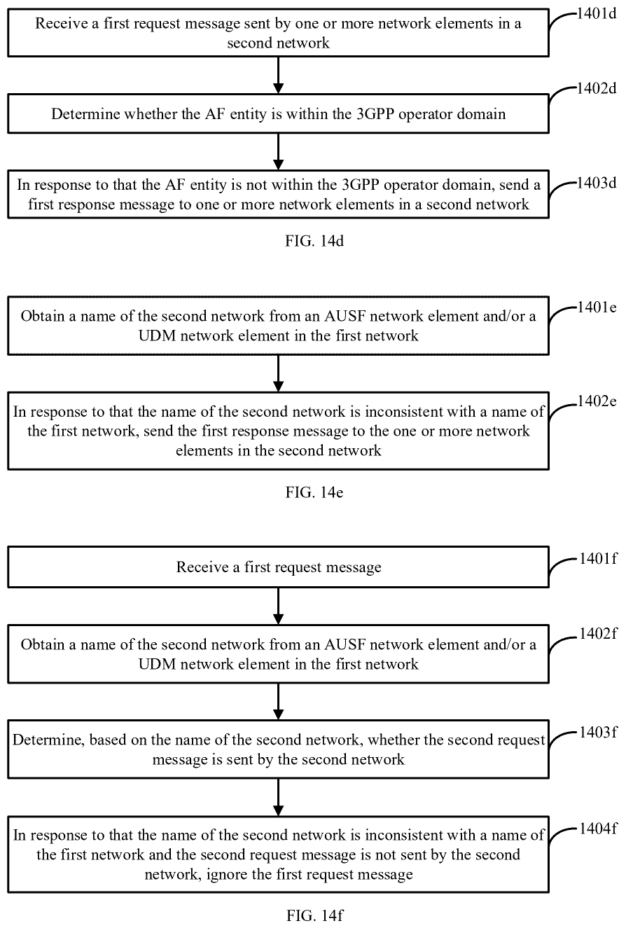

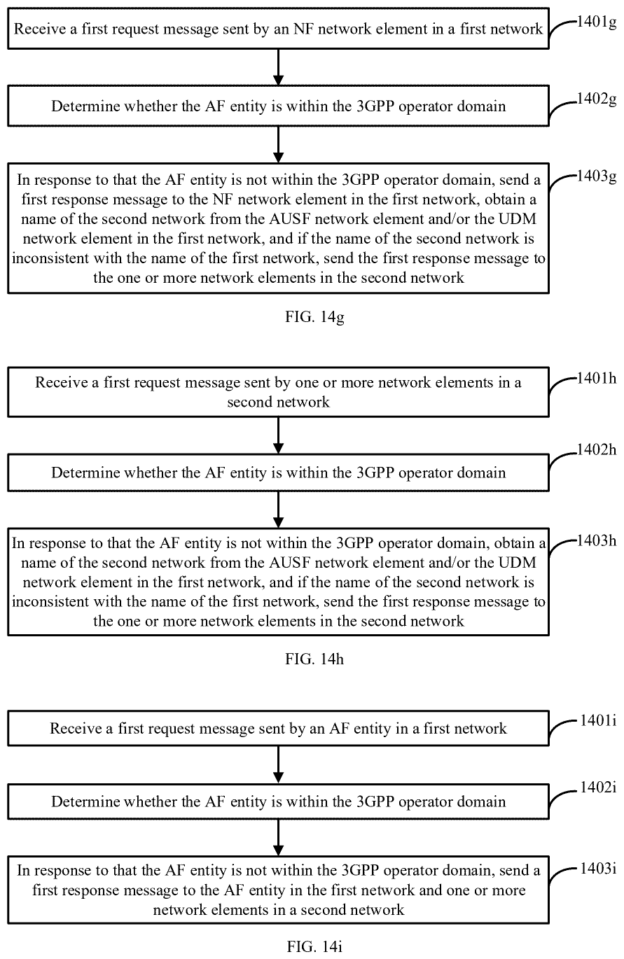

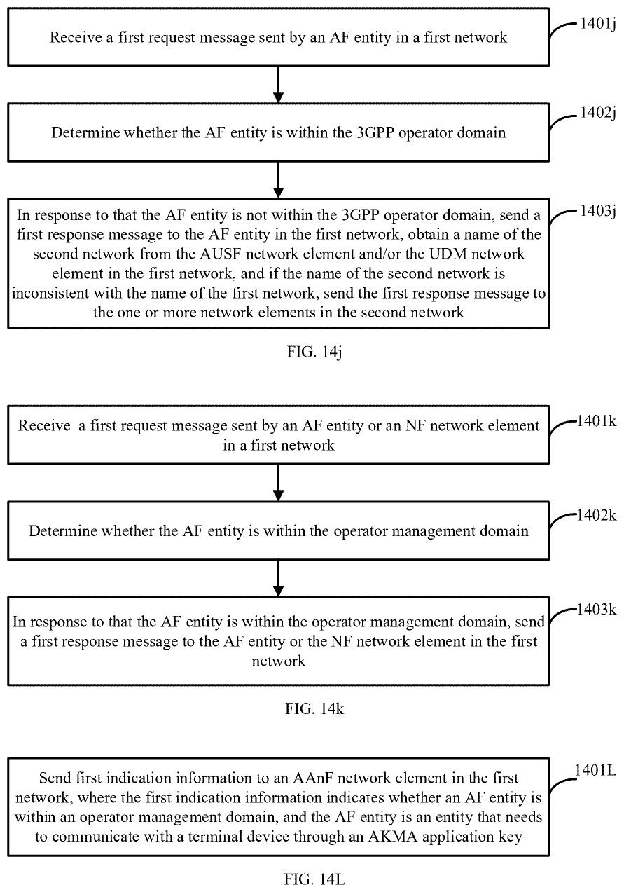

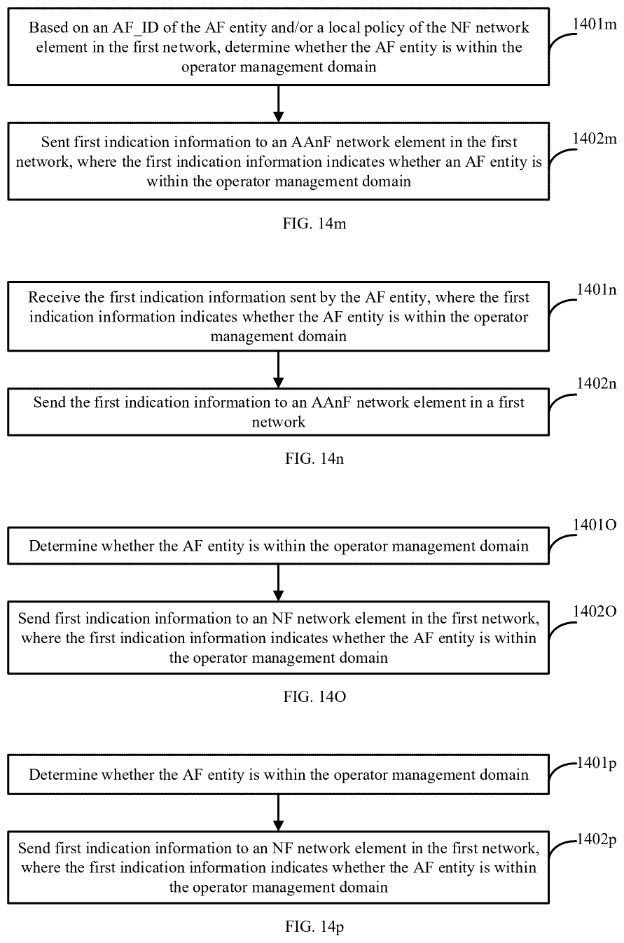

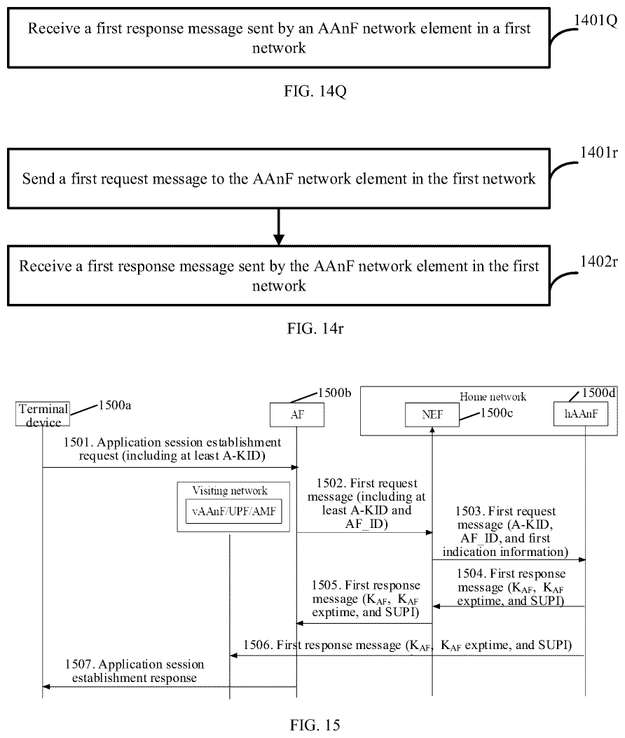

FIG. 14a is a schematic flowchart of a key distribution method provided by an embodiment of the present disclosure. The method is performed by a network element in a second network. As shown in FIG. 14a, the key distribution method may include the following steps 1401a-1402a.

At step 1401a, a first request message is sent to the AAnF network element in the first network.

At step 1402a, a first response message sent by the AAnF network element in the first network is received.

Optionally, in an embodiment of the present disclosure, the one or more network elements in the second network may include at least one of:
an AAnF network element in the second network;
a UPF network element in the second network;
an AMF network element in the second network; or
the NF network element in the second network.

The detailed description of the steps 1401a-1402a may refer to the description of the above embodiments.

To sum up, in the key distribution method provided in the present disclosure, the network element in the second network receives the first response message sent by the AAnF network element in the first network. In the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14b is a schematic flowchart of a key distribution method provided by an embodiment of the present disclosure. The method is performed by an operator for a first network. As shown in FIG. 14, the key distribution method may include the following steps 1401b-1403b.

At step 1401b, a first request message is received, where the first request message is for requesting an AKMA application key.

At step 1402b, it is determined whether the AF entity is within the 3GPP operator domain.

At step 1403b, the AKMA application key is distributed based on a result of the determining.

The detailed description of the steps refers to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14c is a schematic flowchart of a key distribution method provided by an embodiment of the present disclosure. The method is performed by an operator for a first network. As shown in FIG. 14c, the key distribution method may include the following steps 1401c-1403c.

At step 1401c, a first request message sent by an NF network element in a first network is received, where the first request message is for requesting an AKMA application key.

At step 1402c, it is determined whether the AF entity is within the 3GPP operator domain.

At step 1403c, in response to that the AF entity is not within the 3GPP operator domain, a first response message is sent to the NF network element in the first network and one or more network elements in a second network.

The description of the steps may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14d is a schematic flowchart of a key distribution method provided by an embodiment of the present disclosure. The method is performed by an operator for a first network. As shown in FIG. 14d, the key distribution method may include the following steps 1401d-1403d.

At step 1401d, a first request message sent by one or more network elements in a second network is received, where the first request message is for requesting an AKMA application key.

At step 1402d, it is determined whether the AF entity is within the 3GPP operator domain.

At step 1403d, in response to that the AF entity is not within the 3GPP operator domain, a first response message is sent to one or more network elements in a second network.

The detailed description of the steps 1401d-1403d may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14e is a schematic flowchart of a key distribution method provided by an embodiment of the present disclosure. The method is performed by an operator for a first network. As shown in FIG. 14e, the key distribution method may include the following steps 1401e-1402e.

At step 1401e, a name of the second network is obtained from an AUSF network element and/or a UDM network element in the first network.

At step 1402e, in response to that the name of the second network is inconsistent with a name of the first network, the first response message is sent to the one or more network elements in the second network.

The description of the steps may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14f is a schematic flowchart of a key distribution method provided by an embodiment of the present disclosure. The method is performed by an operator for a first network. As shown in FIG. 14f, the key distribution method may include the following steps 1401f-1404f.

At step 1401f, a first request message is received, where the first request message is for requesting an AKMA application key.

It should be noted that a premise of the embodiment of FIG. 1401f in the present disclosure is that the first request message is not sent by the AF entity or the NF network element in the first network to the AAnF network element in the first network.

At step 1402f, a name of the second network is obtained from an AUSF network element and/or a UDM network element in the first network.

At step 1403f, it is determined, based on the name of the second network, whether the second request message is sent by the second network.

At step 1404f, in response to that the name of the second network is inconsistent with a name of the first network and the second request message is not sent by the second network, the first request message is ignored.

The description of the steps may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14g is a schematic flowchart of a key distribution method provided by an embodiment of the present disclosure. The method is performed by an operator for a first network. As shown in FIG. 14g, the key distribution method may include the following steps 1401g-1403g.

At step 1401g, a first request message sent by an NF network element in a first network is received, where the first request message is for requesting an AKMA application key.

At step 1402g, it is determined whether the AF entity is within the 3GPP operator domain.

At step 1403g, in response to that the AF entity is not within the 3GPP operator domain, a first response message is sent to the NF network element in the first network, a name of the second network is obtained from the AUSF network element and/or the UDM network element in the first network, and if the name of the second network is inconsistent with the name of the first network, the first response message is sent to the one or more network elements in the second network.

The detailed description of the steps may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14h is a schematic flowchart of a key distribution method provided by an embodiment of the present disclosure. The method is performed by an operator for a first network. As shown in FIG. 14h, the key distribution method may include the following steps 1401h-1403h.

At step 1401h, a first request message sent by one or more network elements in a second network is received, where the first request message is for requesting an AKMA application key.

At step 1402h, it is determined whether the AF entity is within the 3GPP operator domain.

At step 1403h, in response to that the AF entity is not within the 3GPP operator domain, a name of the second network is obtained from the AUSF network element and/or the UDM network element in the first network, and if the name of the second network is inconsistent with the name of the first network, the first response message is sent to the one or more network elements in the second network.

The detailed description of the steps may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14i is a schematic flowchart of a key distribution method provided by an embodiment of the present disclosure. The method is performed by an operator for a first network. As shown in FIG. 14i, the key distribution method may include the following steps 1401i-1403i.

At step 1401i, a first request message sent by an AF entity in a first network is received, where the first request message is for requesting an AKMA application key.

At step 1402i, it is determined whether the AF entity is within the 3GPP operator domain.

At step 1403i, in response to that the AF entity is not within the 3GPP operator domain, a first response message is sent to the AF entity in the first network and one or more network elements in a second network.

The detailed description of the steps may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14j is a schematic flowchart of a key distribution method provided by an embodiment of the present disclosure. The method is performed by an operator for a first network. As shown in FIG. 14j, the key distribution method may include the following steps 1401j-1403j.

At step 1401j, a first request message sent by an AF entity in a first network is received, where the first request message is for requesting an AKMA application key.

At step 1402j, it is determined whether the AF entity is within the 3GPP operator domain.

At step 1403j, in response to that the AF entity is not within the 3GPP operator domain, a first response message is sent to the AF entity in the first network, a name of the second network is obtained from the AUSF network element and/or the UDM network element in the first network, and if the name of the second network is inconsistent with the name of the first network, the first response message is sent to the one or more network elements in the second network.

The detailed description of the steps may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14k is a schematic flowchart of a key distribution method provided by an embodiment of the present disclosure. The method is performed by an operator for a first network. As shown in FIG. 14k, the key distribution method may include the following steps 1401k-1403k.

At step 1401k, a first request message sent by an AF entity or an NF network element in a first network is received, where the first request message is for requesting an AKMA application key.

At step 1402k, it is determined whether the AF entity is within the 3GPP operator domain.

At step 1403k, in response to that the AF entity is within the 3GPP operator domain, a first response message is sent to the AF entity or the NF network element in the first network.

The detailed description of the steps may refer to the description of the above embodiments.

To sum up, in the key distribution method provided in the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14L is a schematic flowchart of a key distribution method provided by an embodiment of the present disclosure. The method is performed by an operator for a first network. As shown in FIG. 14L, the key distribution method may include the following step 1401L.

At step 1401L, first indication information is sent to an AAnF network element in the first network, where the first indication information indicates whether an AF entity is within a 3GPP operator domain, and the AF entity is an entity that needs to communicate with a terminal device through an AKMA application key.

The detailed description of the step 1401L may refer to the description of the above embodiments.

To sum up, in the key distribution method provided in the present disclosure, the NF network element in the first network may send first indication information to the AAnF network element in the first network, where the first indication information indicates whether the AF entity is within the 3GPP operator domain, and the AF entity is an entity that needs to communicate with the terminal device through the AKMA application key, so that the AAnF network element in the first network determines, based on the first indication message, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14m is a schematic flowchart of a key distribution method provided by an embodiment of the present disclosure. The method is performed by an operator for a first network. As shown in FIG. 14m, the key distribution method may include the following steps 1401m-1402m.

At step 1401m, based on an AF_ID of the AF entity and/or a local policy of the NF network element in the first network, it is determined whether the AF entity is within the 3GPP operator domain.

At step 1402m, first indication information is sent to an AAnF network element in the first network, where the first indication information indicates whether an AF entity is within the 3GPP operator domain, and the AF entity is an entity that needs to communicate with a terminal device through an AKMA application key.

The detailed description of the steps 1401m-1402m may refer to the description of the above embodiments.

To sum up, in the key distribution method provided in the present disclosure, the NF network element in the first network may send first indication information to the AAnF network element in the first network, where the first indication information indicates whether the AF entity is within the 3GPP operator domain, and the AF entity is an entity that needs to communicate with the terminal device through the AKMA application key, so that the AAnF network element in the first network determines, based on the first indication message, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14n is a schematic flowchart of a key distribution method provided by an embodiment of the present disclosure. The method is performed by an operator for a first network. As shown in FIG. 14n, the key distribution method may include the following steps 1401n-1402n.

At step 1401n, the first indication information sent by the AF entity is received, where the first indication information indicates whether the AF entity is within the 3GPP operator domain.

At step 1402n, the first indication information is sent to an AAnF network element in a first network.

The detailed description of the steps may refer to the description of the above embodiments.

To sum up, in the key distribution method provided in the present disclosure, the NF network element in the first network may send first indication information to the AAnF network element in the first network, where the first indication information indicates whether the AF entity is within the 3GPP operator domain, and the AF entity is an entity that needs to communicate with the terminal device through the AKMA application key, so that the AAnF network element in the first network determines, based on the first indication message, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14O is a schematic flowchart of a key distribution method provided by an embodiment of the present disclosure. The method is performed by an operator for a second network. As shown in FIG. 14O, the key distribution method may include the following steps 1401O-1402O.

At step 1401O, it is determined whether the AF entity is within the 3GPP operator domain.

At step 1402O, first indication information is sent to a network function (NF) network element in the first network, where the first indication information indicates whether the AF entity is within the 3GPP operator domain.

The detailed description of the steps may refer to the description of the above embodiments.

To sum up, in the key distribution method provided in the present disclosure, the AF entity determines whether the AF entity is within the 3GPP operator domain, and sends a first indication information to the NF network element in the first network, where the first indication information indicates whether the AF entity is within the 3GPP operator domain, and the NF network element in the first network may send the first indication information to the AAnF network element in the first network, so that the AAnF network element in the first network determines, based on the first indication information, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14p is a schematic flowchart of a key distribution method provided by an embodiment of the present disclosure. The method is performed by an operator for a second network. As shown in FIG. 14p, the key distribution method may include the following steps 1401p-1402p.

At step 1401p, it is determined whether the AF entity is within the 3GPP operator domain.

At step 1402p, first indication information is sent to a network function (NF) network element in the first network, where the first indication information indicates whether the AF entity is within the 3GPP operator domain.

The detailed description of the steps may refer to the description of the above embodiments.

To sum up, in the key distribution method provided in the present disclosure, the AF entity determines whether the AF entity is within the 3GPP operator domain, and sends a first indication information to the NF network element in the first network, where the first indication information indicates whether the AF entity is within the 3GPP operator domain, and the NF network element in the first network may send the first indication information to the AAnF network element in the first network, so that the AAnF network element in the first network determines, based on the first indication information, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14Q is a schematic flowchart of a key distribution method provided by an embodiment of the present disclosure. The method is performed by an operator for a first network. As shown in FIG. 14Q, the key distribution method may include the following step 1401Q.

At step 1401Q, a first response message sent by an AAnF network element in a first network is received.

Optionally, the first response message includes at least one of:
the AKMA application key;
a valid time of the AKMA application key;
an SUPI of a terminal device, where the terminal device is a terminal device with which the AF entity needs to communicate through the AKMA application key.

In an embodiment of the present disclosure, the one or more network elements in the second network may include at least one of:
an AAnF network element in the second network;
a UPF network element in the second network;
an AMF network element in the second network; or
the NF network element in the second network.

The detailed description of the step 1401Q may refer to the description of the above embodiments.

To sum up, in the key distribution method provided in the present disclosure, the network element in the second network receives the first response message sent by the AAnF network element in the first network. In the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 14r is a schematic flowchart of a key distribution method provided by an embodiment of the present disclosure. The method is performed by an operator for a second network. As shown in FIG. 14r, the key distribution method may include the following steps 1401r-1402r.

At step 1401r, a first request message is sent to the AAnF network element in the first network.

At step 1402r, a first response message sent by the AAnF network element in the first network is received.

Optionally, in an embodiment of the present disclosure, the one or more network elements in the second network may include at least one of:
an AAnF network element in the second network;
a UPF network element in the second network;
an AMF network element in the second network; or
the NF network element in the second network.

The detailed description of the steps 1401r-1402r may refer to the description of the above embodiments.

To sum up, in the key distribution method provided in the present disclosure, the network element in the second network receives the first response message sent by the AAnF network element in the first network. In the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

FIG. 15 is a schematic interaction flowchart of a key distribution method provided by an embodiment of the present disclosure. As shown in FIG. 15, the key distribution method may include the following steps 1501-1507.

At step 1501, before the terminal device 1500a initiates communication with the AF entity 1500b, the terminal device obtains a K_{AKMA} and A-KID corresponding to the terminal device from the AUSF network element. When initiating communication with the AF entity, the terminal device sends a session establishment request message to the AF entity where the session establishment request message includes at least the A-KID.

In an embodiment of the present disclosure, the terminal device may also generate K_{AF} (equivalent to the above AKMA application key) based on K_{AKMA} and the A-KID. The terminal device may generate the AKMA application key before or after sending the session establishment request message.

At step 1502, when the AF entity is to request the AKMA application key of the terminal device from the AAnF network element in the first network, the AF entity may find a home public land mobile network (HPLMN) for the terminal device based on the A-KID of the terminal device, and then the AF entity sends an Nnef_AKMA_ApplicationKey_Get request (equivalent to the above first request message) to the NF network element in the first network, where the Nnef_AKMA_ApplicationKey_Get request includes the A-KID and the AF_ID, and optionally includes an ID of the terminal device that does not need to be indicated.

At step 1503, the NF network element 1500c in the first network sends a Naanf_AKMA_ApplicationKey_Get request (equivalent to the above first request message) to an hAAnF network element 1500d (that is, an AAnF network element in the first network), to request an AKMA application key. The Naanf_AKMA_ApplicationKey_Get request may include an A-KID, an AF_ID, and an AF indication (equivalent to the above first indication information).

At step 1504, the hAAnF network element generates an AKMA application key, and sends a first response message to the NF network element in the first network, where the first response message includes a K_{AF} (that is, the AKMA application key), a K_{AF} expiration time (K_{AF} exptime), and the SUPI of the terminal device.

At step 1505, the NF network element in the first network sends a first response message to the AF entity, where the first response message includes the K_{AF}, the K_{AF} expiration time, and optionally a generic public subscription identifier (GPSI) of the terminal device.

At step 1506, if the AF indication (that is, the above first indication information) indicates that the AF entity is within the 3GPP operator domain, the hAAnF network element sends the K_{AF}, the K_{AF} expiration time, the AF_ID, and the SUPI of the terminal device to the vAAnF/UPF/AMF network element in the visited network for the terminal device.

The hAAnF network element may obtain the name of the visited network for the terminal device from the AUSF and/or UDM network element in the home network for the terminal device. Specifically, when providing the K_{AKMA} to the hAAnF network element, the AUSF network element may simultaneously provide the name of the visited network for the terminal device to the hAAnF network element.

At step 1507, the AF entity sends a session establishment response to the terminal device.

If the AKMA application key in step 1504 is unsuccessfully requested, the AF entity should send a session establishment failure response to the terminal device, where the session establishment failure response includes a failure cause. In addition, the UE may subsequently send a new session establishment request to the AF entity with the latest A-KID.

For example, first, for the AF entity, the NF network element in the first network sends the AF indication to the hAAnF network element, to indicate whether the AF entity is within the 3GPP operator domain.

Second, for the hAAnF network element end, if the AF indication indicates that A is outside the operator domain, the hAAnF network element sends the K_{AF}, the K_{AF} expiration time, and the SUPI to the vAAnF/UPF/AMF network element in the visited network for the terminal device. The hAAnF network element may obtain the name of the visited network for the terminal device from the AUSF/UDM network element in the home network for the terminal device.

Third, the vAAnF/AMF/UPF network element in the visited network for the terminal device should be able to receive the K_{AF}, the K_{AF} expiration time, the AF_ID, and the SUPI of the hAAnF network element in the home network for the terminal device.

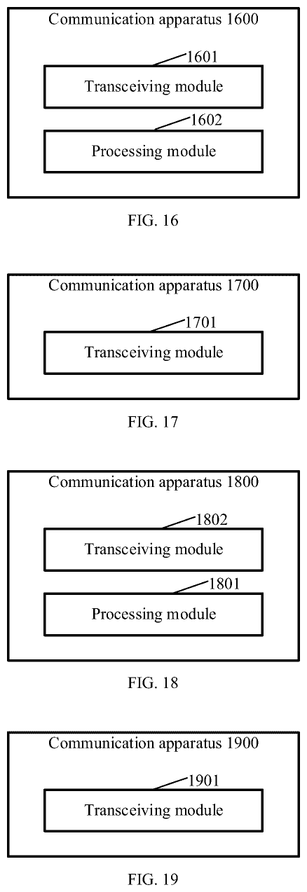

FIG. 16 is a schematic structural diagram of a communication apparatus 1600 provided by an embodiment of the present disclosure. As shown in FIG. 16, the apparatus may include:
a transceiving module 1601, configured to receive a first request message, where the first request message is for requesting an AKMA application key; and
a processing module 1602, configured to determine whether an AF entity is within a 3GPP operator domain, where the AF entity is an entity that needs to communicate with a terminal device through the AKMA application key;
where the transceiving module is further configured to distributing the AKMA application key based on a result of the determining.

To sum up, in the key distribution apparatus provided in the embodiment of the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

Optionally, in an embodiment of the present disclosure, the transceiving module is further configured to:
receive the first request message sent by a network function (NF) network element in the first network.

Optionally, in an embodiment of the present disclosure, the transceiving module is further configured to:
receive the first request message sent by one or more network elements in a second network.

Optionally, in an embodiment of the present disclosure, the first request message includes at least one of:
an A-KID;
an AF_ID of the AF entity; or
an identifier of the terminal device, where the terminal device is a terminal device with which the AF entity needs to communicate through the AKMA application key.

Optionally, in an embodiment of the present disclosure, the first network is a home network for the terminal device; and
the second network is a current visited network for the terminal device.

Optionally, in an embodiment of the present disclosure, the processing module is further configured to:
determine, based on the AF_ID and/or a local policy of the AAnF network element, whether the AF entity is within the 3GPP operator domain.

Optionally, in an embodiment of the present disclosure, the processing module is further configured to:
receive first indication information sent by an NF network element in the first network, where the first indication information indicates whether the AF entity is within the 3GPP operator domain; and
determine, based on the first indication information, whether the AF entity is within the 3GPP operator domain.

Optionally, in an embodiment of the present disclosure, the transceiving module is further configured to:
send, in response to that the AF entity is not within the 3GPP operator domain, a first response message to the NF network element in the first network and one or more network elements in a second network.

Optionally, in an embodiment of the present disclosure, the transceiving module is further configured to:
send, in response to that the AF entity is not within the 3GPP operator domain, a first response message to the one or more network elements in the second network.

Optionally, in an embodiment of the present disclosure, the first response message includes at least one of:
the AKMA application key;
a valid time of the AKMA application key; or
an invalid time of the AKMA application key;
an SUPI of the terminal device; or
an AF_ID of the AF entity.

Optionally, in an embodiment of the present disclosure, the apparatus is further configured to:
obtain a name of the second network from an AUSF network element and/or a UDM network element in the first network.

Optionally, in an embodiment of the present disclosure, the transceiving module is further configured to:
send, in response to that the name of the second network is inconsistent with a name of the first network, the first response message to the one or more network elements in the second network.

Optionally, in an embodiment of the present disclosure, the apparatus is configured to:
receive the name of the second network that is provided simultaneously by the AUSF network element when the AUSF network element sends an AKMA anchor key (K_{AKMA}).

Optionally, in an embodiment of the present disclosure, the one or more network elements in the second network includes at least one of:
an AAnF network element in the second network;
a UPF network element in the second network;
an AMF network element in the second network; or
the NF network element in the second network.

FIG. 17 is a schematic structural diagram of a communication apparatus 1700 provided by an embodiment of the present disclosure. As shown in FIG. 17, the apparatus may include:
a transceiving module 1701, configured to send first indication information to an AAnF network element in the first network, where the first indication information indicates whether an AF entity is within a 3GPP operator domain, and the AF entity is an entity that needs to communicate with a terminal device through an AKMA application key.

To sum up, in the key distribution apparatus provided in the embodiment of the present disclosure, the NF network element in the first network may send first indication information to the AAnF network element in the first network, where the first indication information indicates whether the AF entity is within the 3GPP operator domain, and the AF entity is an entity that needs to communicate with the terminal device through the AKMA application key, so that the AAnF network element in the first network determines, based on the first indication message, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

Optionally, in an embodiment of the present disclosure, the first network is a home network for the terminal device.

Optionally, in an embodiment of the present disclosure, the apparatus is further configured to:
determine, based on an AF_ID and/or a local policy of the NF network element in the first network, whether the AF entity is within the 3GPP operator domain.

Optionally, in an embodiment of the present disclosure, the apparatus is further configured to:
receive the first indication information sent by the AF entity, where the first indication information indicates whether the AF entity is within the 3GPP operator domain.

FIG. 18 is a schematic structural diagram of a communication apparatus 1800 provided by an embodiment of the present disclosure. As shown in FIG. 18, the apparatus may include:
a processing module 1801, configured to determine whether the AF entity is within a 3GPP operator domain; and
a transceiving module 1802, configured to send first indication information a network function (NF) network element in a first network, where the first indication information indicates whether the AF entity is within the 3GPP operator domain.

To sum up, in the key distribution apparatus provided in the embodiment of the present disclosure, the AF entity determines whether the AF entity is within the 3GPP operator domain, and sends a first indication information to the NF network element in the first network, where the first indication information indicates whether the AF entity is within the 3GPP operator domain, and the NF network element in the first network may send the first indication information to the AAnF network element in the first network, so that the AAnF network element in the first network determines, based on the first indication information, whether the AF entity is within the 3GPP operator domain; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

Optionally, in an embodiment of the present disclosure, the first network is a home network for a terminal device, and the terminal device is a terminal device with which the AF entity needs to communicate through an AKMA application key.

FIG. 19 is a schematic structural diagram of a communication apparatus 1900 provided by an embodiment of the present disclosure. As shown in FIG. 19, the apparatus may include:
a transceiving module 1901, configured to receive a first response message sent by an AAnF network element in a first network;
where the first response message includes at least one of:
the AKMA application key;
a valid time of the AKMA application key; or
an invalid time of the AKMA application key;
an SUPI of a terminal device, where the terminal device is a terminal device with which the AF entity needs to communicate through the AKMA application key; or
an AF_ID of the AF entity.

To sum up, in the communication apparatus provided in the embodiment of the present disclosure, the network element in the second network receives the first response message sent by the AAnF network element in the first network. In the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

Optionally, in an embodiment of the present disclosure, the first network is a home network for the terminal device; and the second network is a current visited network for the terminal device.

Optionally, in an embodiment of the present disclosure, the one or more network elements in the second network includes at least one of:
an AAnF network element in the second network;
a UPF network element in the second network;
an AMF network element in the second network; or
the NF network element in the second network.

Optionally, in an embodiment of the present disclosure, the apparatus is further configured to:
send a first request message to the AAnF network element in the first network;
where the request response message includes at least one of:
an AF_ID of the AF entity; or
an identifier of the terminal device.

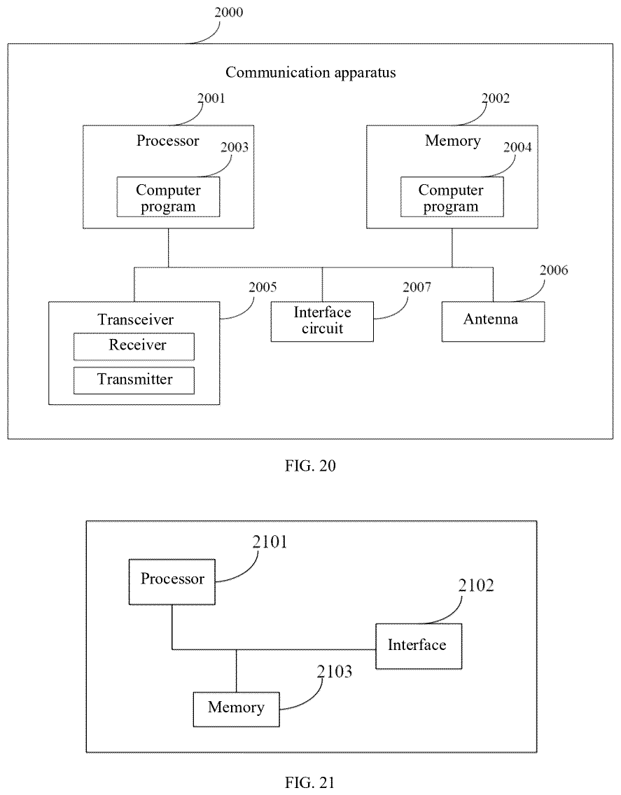

Referring to FIG. 20, FIG. 20 is schematic structural diagram of a communication apparatus 2000 provided by an embodiment of the present disclosure. The communication apparatus 2000 may be a network device or a terminal device; the communication apparatus 2000 may also be a chip, a chip system, or a processor that supports the network device to implement the above methods, etc.; or, the communication apparatus 2000 may also be a chip, a chip system, or a processor that supports the terminal device to implement the above methods. This apparatus may be configured to implement the methods described in the above method embodiments, which may specifically refer to the description in the above method embodiments.

The communication apparatus 2000 may include one or more processors 2001. The processors 2001 may be general-purpose processors, special-purpose processors, etc. For example, the processors may be baseband processors or central processing units. The baseband processor may be configured to process a communication protocol and communication data, and the central processing unit may be configured to control the communication apparatus (for example, a base station, a baseband chip, a terminal device, a terminal device chip, a DU, a CU, etc.), executing a computer program, and processing data of the computer program.

Optionally, the communication apparatus 2000 may further include one or more memories 2002. The one or more memories 2002 may store a computer program 2004, and the processors 2001 execute the computer program 2004 to cause the communication apparatus 2000 to perform the methods described in the above method embodiments. Optionally, the memories 2002 may further store data. The communication apparatus 2000 and the memories 2002 may be separately configured, or may be integrated together.

Optionally, the communication apparatus 2000 may further include a transceiver 2005 and an antenna 2006. The transceiver 2005 may be referred to as a transceiver unit, a transceiver machine, a transceiver circuit, etc., and is configured to implement a transceiving function. The transceiver 2005 may include a receiver and a transmitter. The receiver may be referred to as a receiving machine, a receiving circuit, etc., and is configured to implement a receiving function. The transmitter may be referred to as a transmitting machine, a transmitting circuit, etc., and is configured to implement a transmitting function.

Optionally, the communication apparatus 2000 may further include one or more interface circuits 2007. The interface circuits 2007 are configured to receive code instructions and transmitting the code instructions to the processor 2001. The processor 2001 executes the code instructions to cause the communication apparatus 2000 to perform the methods described in the above method embodiments.

In an implementation, the processor 2001 may include a transceiver for implementing the receiving and sending functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface, or the interface circuit may be configured to read and write codes/data, or the transceiving circuit, the interface, or the interface circuit may be configured to transmit or transfer a signal.

In an implementation, the processor 2001 may store a computer program 2003, and the computer program 2003 is performed by the processor 2001, so that the communication apparatus 2000 may perform the methods described in the above method embodiments. The computer program 2003 may be fixed in the processor 2001, and in this case, the processor 2001 may be implemented by hardware.

In an implementation, the communication apparatus 2000 may include a circuit, and the circuit may implement transmitting, receiving, or communicating functions in the above method embodiments. The processor and transceiver described in the present disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and transceiver may also be fabricated with various IC process technologies, such as a complementary metal oxide semiconductor (CMOS), an n-metal oxide semiconductor (NMOS), a p-metal oxide semiconductor (positive channel metal oxide semiconductor, PMOS), a bipolar junction transistor (BJT), a bipolar CMOS (BiCMOS), a silicon germanium (SiGe), a gallium arsenide (GaAs), etc.

The communication apparatus described in the above embodiments may be a network device or a terminal device, but a scope of the communication apparatus described in the present disclosure is not limited thereto, and a structure of the communication apparatus may not be limited by FIG. 20. The communication apparatus may be a separate device or may be a part of a larger device. For example, the communication apparatus may be:
(1) a separate integrated circuit IC, chip, or chip system or subsystem;
(2) a set of one or more ICs; optionally, the set of ICs may also include a storage component for storing data and a computer program;
(3) an ASIC, for example, a modem;
(4) a module that may be embedded within other devices;
(5) a receiving machine, a terminal device, an intelligent terminal device, a cellular phone, a wireless device, a handset, a mobile unit, an in-vehicle device, a network device, a cloud device, an artificial intelligence device, etc.; or
(6) other apparatus, etc.

The case in which the communication apparatus may be a chip or a chip system may refer to the schematic structural diagram of the chip shown in FIG. 21. The chip shown in FIG. 21 includes a processor 2101 and an interface 2102. There may be one or more processors 2101, and there may be multiple interfaces 2102.

Optionally, the chip further includes a memory 2103, and the memory 2103 is configured to store a necessary computer program and data.

Those skilled in the art may also understand that various illustrative logical blocks and steps listed in the embodiments of the present disclosure may be implemented by using electronic hardware, computer software, or a combination of the two. Whether such function is implemented by hardware or software depends on specific applications and design requirements of an overall system. Those skilled in the art may use various methods to implement the functions for each specific application, but this implementation should not be understood as going beyond the protection scope of the embodiments of the present disclosure.

The present disclosure further provides a readable storage medium storing instructions. When the instructions are executed by a computer, functions of any one of the above method embodiments are implemented.

The present disclosure further provides a computer program product. When the computer program product is executed by a computer, the functions of any one of the above method embodiments are implemented.

In the above embodiments, it may be implemented in whole or in part by software, hardware, firmware, or any combination thereof. When implemented in software, it may be implemented in whole or in part in the form of a computer program product. The computer program product includes one or more computer programs. When the computer program is loaded and executed on a computer, the processes or functions according to embodiments of the present disclosure are generated in whole or in part. The computer may be a general purpose computer, a special purpose computer, a computer network, or other programmable apparatus. The computer programs may be stored in a computer readable storage medium or transmitted from one computer readable storage medium to another computer readable storage medium. For example, the computer programs may be transmitted from a website site, computer, server or data center to another website site, computer, server or data center by a wired (for example, a coaxial-cable, a fiber, a digital subscriber line (DSL)) or wirelessly (for example, infrared, wireless, microwave, etc.) manner. The computer readable storage medium may be any available medium that can be accessed by a computer or may be a data storage device, such as a server, data center, or the like, including one or more integrated available mediums. The available medium may be a magnetic medium (for example, a floppy disk, a hard disk, a magnetic tape), an optical medium (for example, a digital video disc (DVD)), or a semiconductor medium (for example, a solid state disk (SSD)), etc.

In a first aspect, an embodiment of the present disclosure provides a key distribution method. The method is performed by a first authentication and key management for applications anchor function (AAnF) network element, and includes: receiving a first request message, where the first request message is for requesting an authentication and key management for applications (AKMA) application key; determining whether an application function (AF) entity is within a 3rd generation partnership project (3GPP) operator domain, where the AF entity is an entity that needs to communicate with a terminal device through the AKMA application key; and distributing the AKMA application key based on a result of the determining.

In the present disclosure, the AAnF network element in the first network receives the first request message, where the first request message is for requesting the AKMA application key; the AAnF network element in the first network further determines whether the AF entity is within the 3GPP operator domain, where the AF entity is an entity that needs to communicate with the terminal device through the AKMA application key; and the AAnF network element in the first network distributes the AKMA application key based on a result of the determining. Therefore, in the present disclosure, the AAnF network element in the first network may distribute the AKMA application key according to a result of determining whether the AF entity is within the 3GPP operator domain. Therefore, when determining that the AF entity is not within the 3GPP operator domain, the AAnF network element in the first network (that is, the home network) may take a corresponding means when distributing the AKMA application key, to ensure that the second network (that is, the visited network) can know the AKMA application key, thereby ensuring that the service is successfully performed.

In a second aspect, an embodiment of the present disclosure provides a key distribution method. The method is performed by an NF network element in a first network, and includes: sending first indication information to an authentication and key management for applications anchor function (AAnF) network element in the first network, where the first indication information indicates whether an AF entity is within a 3GPP operator domain, and the AF entity is an entity that needs to communicate with a terminal device through an AKMA application key.

In a third aspect, an embodiment of the present disclosure provides a key distribution method. The method is performed by an AF entity, and includes: determining whether the AF entity is within a 3GPP operator domain; and sending first indication information to a network function (NF) network element in a first network, where the first indication information indicates whether the AF entity is within the 3GPP operator domain.

In a fourth aspect, an embodiment of the present disclosure provides a key distribution method. The method is performed by an NF network element in a second network, and includes: receiving a first response message sent by an AAnF network element in a first network; where the first response message includes at least one of: the AKMA application key; a valid time of the AKMA application key; or an invalid time of the AKMA application key; an SUPI of a terminal device, where the terminal device is a terminal device with which the AF entity needs to communicate through the AKMA application key; or an identifier of the AF entity (AF_ID).

In a fifth aspect, an embodiment of the present disclosure provides a communication apparatus. The apparatus is configured in an AAnF network element in a first network and includes: a transceiving module, configured to receive a first request message, where the first request message is for requesting an AKMA application key; and a processing module, configured to determine whether an AF entity is within a 3GPP operator domain, where the AF entity is an entity that needs to communicate with a terminal device through the AKMA application key; where the transceiving module is further configured to distributing the AKMA application key based on a result of the determining.

In a sixth aspect, an embodiment of the present disclosure provides a communication apparatus. The apparatus is configured in an NF network element in a first network and includes: a transceiving module, configured to send first indication information to an AAnF network element in the first network, where the first indication information indicates whether an AF entity is within a 3GPP operator domain, and the AF entity is an entity that needs to communicate with a terminal device through an AKMA application key.

In a seventh aspect, an embodiment of the present disclosure provides a communication apparatus. The apparatus is configured in an AF entity and includes: a processing module, configured to determine whether the AF entity is within a 3GPP operator domain; and a transceiving module, configured to send first indication information a network function (NF) network element in the first network, where the first indication information indicates whether the AF entity is within the 3GPP operator domain.

In an eighth aspect, an embodiment of the present disclosure provides a communication apparatus. The apparatus is configured in a network element in a second network and includes: a transceiving module, configured to receive a first response message sent by an AAnF network element in a first network; where the first response message includes at least one of: the AKMA application key; a valid time of the AKMA application key; or an invalid time of the AKMA application key; an SUPI of a terminal device, where the terminal device is a terminal device with which the AF entity needs to communicate through the AKMA application key; or an identifier of the AF entity (AF_ID).

In a ninth aspect, an embodiment of the present disclosure provides a communication apparatus. The communication apparatus includes a processor, and the processor, when invoking a computer program in a memory, perform the method in any one of the first to fourth aspects.

In a tenth aspect, an embodiment of the present disclosure provides a communication apparatus. The communication apparatus includes a processor and a memory, the memory stores a computer program, and the processor executes the computer program stored in the memory, to cause the communication apparatus to perform the method in any one of the first to fourth aspects.

In an eleventh aspect, an embodiment of the present disclosure provides a communication apparatus. The apparatus includes a processor and an interface circuit. The interface circuit is configured to receive code instructions and transmitting the code instructions to the processor, and the processor is configured to execute the code instructions to cause the apparatus to perform the method in any one of the first to fourth aspects.

In a twelfth aspect, an embodiment of the present disclosure provides a communication system. The system includes the communication apparatuses in the fifth to eighth aspects, the system includes the communication apparatus in the ninth aspect, the system includes the communication apparatus in the tenth aspect, or the system includes the communication apparatus in the eleventh aspect.

In a thirteenth aspect, an embodiment of the present disclosure provides a computer-readable storage medium, configured to store instructions used for the above network device. When the instructions are executed, the terminal device performs the method in any one of the first to fourth aspects.

In a fourteenth aspect, the present disclosure further provides a computer program product including a computer program. When the computer program is executed by a computer, the computer performs the method in any one of the first to fourth aspects.

In a fifteenth aspect, the present disclosure provides a chip system. The chip system includes at least one processor and an interface, and is configured to support the network device to implement the functions involved in the method in any one of the first to fourth aspects, for example, determining or processing at least one of data and information involved in the above methods. In a possible design, the chip system further includes a memory, and the memory is configured to store a computer program and data that are necessary for the processor. The chip system may be composed of a chip, or may include a chip and other discrete components.

In a sixteenth aspect, the present disclosure further provides a computer program. When the computer program is executed by a computer, the computer performs the method in any one of the first to fourth aspects.

Those skilled in the art may understand that various numerical numbers such as “first” and “second” involved in the present disclosure are only for distinguishing for the convenience of description and are not intended to limit the scope of the embodiments of the present disclosure, and do not also represent an early-later sequence.

“At least one” in the present disclosure may also be described as one or more, and “a plurality of/multiple” may be two, three, four or more, which is not limited in the present disclosure. In the embodiments of the present disclosure, for a kind of technical features, technical features in the kind of technical features are distinguished by “first”, “second”, “third”, “A”, “B”, “C”, and “D”, etc., and there is no an early-later sequence or a large-small sequence among the technical features described by “first”, “second”, “third”, “A”, “B”, “C”, and “D”.

The correspondence relationships shown in each table in the present disclosure may be configured or predefined. Values of the information in each table are merely examples, and may be configured as other values, which is not limited in the present disclosure. When configuring correspondence relationships between the information and each parameter, it is not necessarily required to configure all the correspondence relationships shown in each table. For example, correspondence relationships shown in certain rows may also not be configured in the tables in the present disclosure. For another example, appropriate deformation adjustment may be performed based on the above tables, for example, splitting, merging, etc. A name of a parameter shown by a title in each of the above tables may also be another name that may be understood by the communication apparatus, and a value or a representation manner of the parameter may also be another value or representation manner that may be understood by the communication apparatus. During implementation of each of the above tables, other data structures may also be used, for example, an array, a queue, a container, a stack, a linear table, a pointer, a linked list, a tree, a graph, a structure body, a class, a heap, a hashing table of a hash table, etc., may be used.

Predefinition in the present disclosure may be understood as defining, pre-defining, storing, pre-storing, pre-negotiating, pre-configuring, curing, or pre-firing.

Those skilled in the art can realize that the units and algorithm steps of each example described in connection with the embodiments disclosed herein can be implemented in electronic hardware, or a combination of computer software and electronic hardware. Whether these functions are performed in hardware or software depends on the specific application and the design constraint condition of the technical solution. Professional technicians may use different methods to implement the described functions for each specific application, but such implementation should not be considered to be beyond the scope of the present disclosure.

Those skilled in the art may clearly understand that for the convenience and conciseness of the description, the specific working processes of the system, apparatus, and unit described above may refer to the corresponding processes in the aforementioned method embodiments, and will not be repeated here.

The above description is only specific implement manner of the present disclosure, and the protection scope of the present disclosure is not limited thereto. Any alteration or substitution that can be easily conceived by any those skilled in the art within the technical scope disclosed by the present disclosure shall fall within the protection scope of the present disclosure. Therefore, the protection scope of the present disclosure shall be subject to the protection scope of the claims.

1. A key distribution method, performed by an authentication and key management for applications anchor function (AAnF) network element in a first network and comprising:
receiving a first request message, wherein the first request message is for requesting an authentication and key management for applications (AKMA) application key;
determining whether an application function (AF) entity is within a 3rd generation partnership project (3GPP) operator domain, wherein the AF entity is an entity for which the AKMA application key is requested to communicate with a terminal device; and
distributing the AKMA application key based on a result of the determining.

2. The method of claim 1, wherein the receiving a first request message, comprises any one of:
receiving the first request message sent by a network function (NF) network element in the first network, wherein the first network is a home network for the terminal device; or
receiving the first request message sent by one or more network elements in a second network, wherein the second network is a current visited network for the terminal device.

3. (canceled)

4. The method of claim 2 or 3, wherein the first request message comprises at least one of:
an AKMA key identifier (A-KID);
an identifier of the AF entity (AF_ID); or
an identifier of the terminal device.

5. (canceled)

6. The method of claim 1, wherein the determining whether an AF entity is within a 3GPP operator domain, comprises any one of:
determining, based on an AF_ID of the AF entity and/or a local policy of the AAnF network element, whether the AF entity is within the 3GPP operator domain; or
determining, based on first indication information sent by an NF network element in the first network, whether the AF entity is within the 3GPP operator domain, wherein the first network is a home network for the terminal device, and the first indication information indicates whether the AF entity is within the 3GPP operator domain.

7. (canceled)

8. The method of claim 2, wherein the distributing the AKMA application key based on a result of the determining, comprises any one of:
sending, in response to determining that the AF entity is not within the 3GPP operator domain, a first response message to the NF network element in the first network and the one or more network elements in the second network; or
sending, in response to determining that the AF entity is not within the 3GPP operator domain, the first response message to the one or more network elements in the second network.

9. (canceled)

10. The method of claim 8, wherein the first response message comprises at least one of:
the AKMA application key;
a valid time of the AKMA application key;
an invalid time of the AKMA application key;
a subscription permanent identifier (SUPI) of the terminal device; or
an AF_ID of the AF entity.

11. The method of claim 8 or 9, further comprising:
obtaining a name of the second network from an authentication server function (AUSF) network element and/or a unified data management (UDM) network element in the first network;
wherein the sending a first response message to the one or more network elements in the second network, comprises: sending, in response to that the name of the second network is inconsistent with a name of the first network, the first response message to the one or more network elements in the second network.

12. (canceled)

13. The method of claim 11, wherein the obtaining a name of the second network from an AUSF network element in the first network, comprises:
receiving the name of the second network that is provided simultaneously by the AUSF network element when the AUSF network element sends an AKMA anchor key (K_{AKMA}).

14. The method of claim 8, wherein the one or more network elements in the second network comprise at least one of:
an AAnF network element in the second network;
a user plane function (UPF) network element in the second network;
an access and mobility management function (AMF) network element in the second network; or
an NF network element in the second network.

15. A key distribution method, performed by a network function (NF) network element in a first network and comprising:
sending first indication information to an authentication and key management for applications anchor function (AAnF) network element in the first network, wherein the first indication information indicates whether an application function (AF) entity is within a 3rd generation partnership project (3GPP) operator domain, and the AF entity is an entity that needs to communicate with a terminal device through an authentication and key management for applications (AKMA) application key.

16. (canceled)

17. The method of claim 15, further comprising:
determining, based on an identifier of the AF entity (AF_ID) and/or a local policy of the NF network element in the first network, whether the AF entity is within the 3GPP operator domain.

18. The method of claim 15, further comprising:
receiving the first indication information sent by the AF entity, wherein the AF entity determines whether the AF entity is within the 3GPP operator domain.

19.-20. (canceled)

21. A key distribution method, performed by a network element in a second network and comprising:
receiving a first response message sent by an authentication and key management for applications anchor function (AAnF) network element in a first network;
wherein the first response message comprises at least one of:
an authentication and key management for applications (AKMA) application key;
a valid time of the AKMA application key;
an invalid time of the AKMA application key;
a subscription permanent identifier (SUPI) of a terminal device, wherein the terminal device is a terminal device with which an application function (AF) entity needs to communicate through the AKMA application key; or
an identifier of the AF entity (AF_ID).

22.-23. (canceled)

24. The method of claim 21, further comprising:
sending a first request message to the AAnF network element in the first network;
wherein the request response message comprises at least one of:
the AF_ID; or
an identifier of the terminal device.

25.-28. (canceled)

29. A communication apparatus, comprising a processor and a memory, wherein the memory stores a computer program, and the processor executes the computer program stored in the memory to cause the apparatus to perform the method of claim 1.

30. (canceled)

31. A non-transitory computer-readable storage medium, configured to store instructions, wherein the method of claim 1.

32. A communication apparatus, comprising a processor and a memory, wherein the memory stores a computer program, and the processor executes the computer program stored in the memory to cause the apparatus to perform the method of claim 15.

33. A communication apparatus, comprising a processor and a memory, wherein the memory stores a computer program, and the processor executes the computer program stored in the memory to cause the apparatus to perform the method of claim 21.

34. A non-transitory computer-readable storage medium, configured to store instructions, wherein the method of claim 15 is implemented when the instructions are executed.

35. A non-transitory computer-readable storage medium, configured to store instructions, wherein the method of claim 21 is implemented when the instructions are executed.
